(19) United States
(12) Patent Application Publication
(10) Pub. No.: US 2016/0078008 A1
(43) Pub. Date: Mar. 17, 2016

(54) INTEGRATING USER INTERFACE EXPERIENCES FROM MULTIPLE APPLICATIONS

(71) Applicant: Microsoft Corporation, Redmond, WA (US)

(72) Inventors: Evgueni Bykov, Bothell, WA (US); Ryan Benson, Renton, WA (US); Daniel Savage, Sammamish, WA (US)

(21) Appl. No.: 14/483,592

(22) Filed: Sep. 11, 2014

(51) Int. Cl. G06F 17/22; G06F 17/21

(52) U.S. Cl. CPC G06F 17/2247; G06F 17/211

(57) ABSTRACT

Embodiments are directed to integrating experiences from at least two applications. In one scenario, an application at a computer system generates a request for visually-interpretable information from another application, where the second application is decoupled from the first application. The request includes context information associated with the first application. The computer system sends the generated request to the second application and receives visually-interpretable information from the second application. The visually-interpretable information is generated based on the context information associated with the first application. In some cases, the visually-interpretable information includes web page data displayable in a web browser application.

### BACKGROUND

Computing systems have become ubiquitous, ranging from small embedded devices to phones and tablets to PCs and backend servers. Each of these computing systems is designed to process software code. The software allows users to perform functions, interacting with the hardware provided by the computing system. Many different software applications may be run on a single computing system. Each of these applications typically has different security boundaries and connectivity means. In some cases, it may be difficult to facilitate integration between applications having such disparate security boundaries or connectivity means.

### BRIEF SUMMARY

Embodiments described herein are directed to integrating experiences from at least two applications. In one embodiment, an application at a computer system generates a request for visually-interpretable information from another application, where the second application is decoupled from the first application. The request includes context information associated with the first application. The computer system sends the generated request to the second application and receives visually-interpretable information from the second application. The visually-interpretable information is generated based on the context information associated with the first application. In some cases, the visually-interpretable information includes web page data displayable in a web browser application.

In another embodiment, an application at a computer system generates a request for visually-interpretable information from another application, where the second application is decoupled from the first application, and where the request includes context information associated with the first application. The computer system sends the generated request to the second application and receives visually-interpretable information from the second application. The visually-interpretable information is generated based on the context information associated with the first application, and includes instructions for the first application that include context information associated with the second application. The computer system then interprets the received instructions including the context information associated with the second application to allow the first application to perform an action based on the received instructions.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including integrating experiences from at least two applications.

FIG. 2 illustrates a flowchart of an example method for integrating experiences from at least two applications.

FIG. 3 illustrates a flowchart of an alternative example method for integrating experiences from at least two applications.

FIG. 4 illustrates an embodiment in which a contextual widget displays details of a selected object.

FIG. 5 illustrates an embodiment in which a data request is generated by a scripting widget, and a web page response is returned.

FIG. 6 illustrates an embodiment in which a custom web page is requested, generated and provided.

FIG. 7 illustrates an embodiment in which a script is executed to generate a web page request which is fulfilled by providing a web page.

### DETAILED DESCRIPTION

Embodiments described herein are directed to integrating experiences from at least two applications. In one embodiment, an application at a computer system generates a request for visually-interpretable information from another application, where the second application is decoupled from the first application. The request includes context information associated with the first application. The computer system sends the generated request to the second application and receives visually-interpretable information from the second application. The visually-interpretable information is generated based on the context information associated with the first application. In some cases, the visually-interpretable information includes web page data displayable in a web browser application.

In another embodiment, an application at a computer system generates a request for visually-interpretable information from another application, where the second application is decoupled from the first application, and where the request includes context information associated with the first application. The computer system sends the generated request to the second application and receives visually-interpretable information from the second application. The visually-interpretable information is generated based on the context information associated with the first application, and includes instructions for the first application that include context information associated with the second application. The computer system then interprets the received instructions including the context information associated with the second application to allow the first application to perform an action based on the received instructions.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

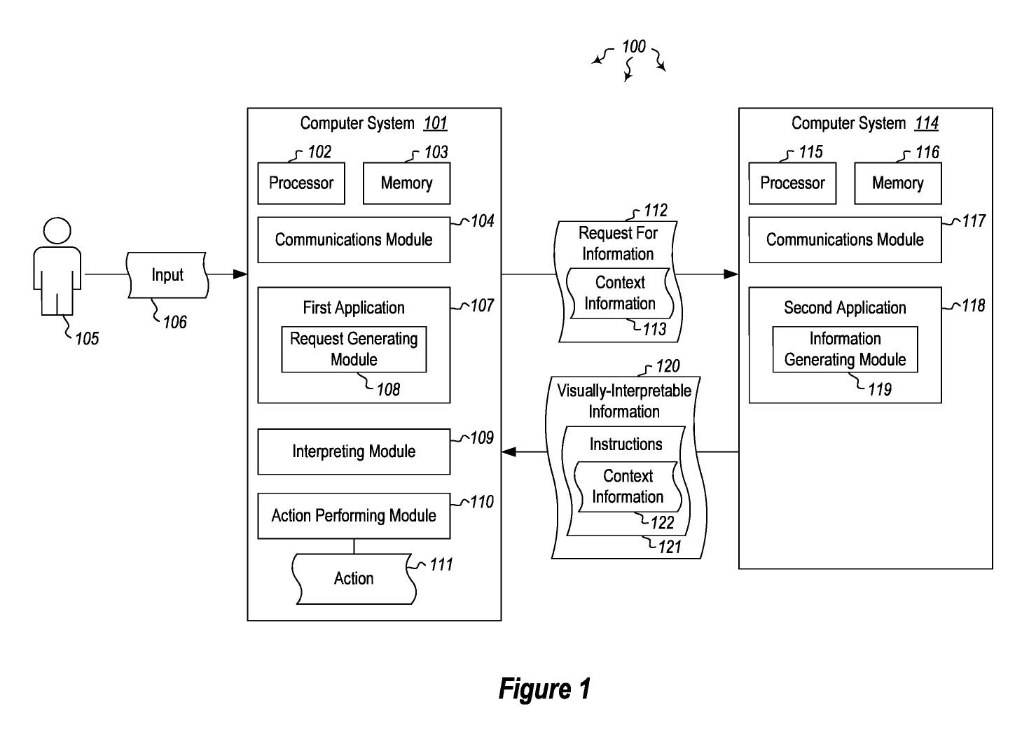

As illustrated in FIG. 1, a computing system 101 typically includes at least one processing unit 102 and memory 103. The memory 103 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes two computer systems: 101 and 114, although more or fewer may be used. The computer systems 101 and 114 may be any type of local or distributed computer systems, including a cloud computing system. The computer systems 101 and 114 include modules for performing a variety of different functions. For instance, the communications module 104 may be configured to communicate with other computing systems, such as with the communications module 117 of computer system 114. The computing module 104 may include any wired or wireless communication means that can receive and/or transmit data to or from other computing systems. The communications module 104 may be configured to interact with databases, mobile computing devices (such as mobile phones or tablets), embedded or other types of computing systems. Each computer system includes physical hardware including a processor (102/115) or processing cores, and some type of memory 103/116 such as random access memory. Each computer system may also include or have access to local or remote data storage such as a database or local hard drive.

The computer systems 101 and 114 may be designed to run applications. For instance, computer system 101 may run first application 107, while computer system 114 may be configured to run second application 118. These applications may be any type of software applications including services or other portions of software functionality. The first and second applications may have different attributes, or may be configured differently. In some cases, the first application 107 and the second application 118 may have different security boundaries or connectivity boundaries. For instance, the first application 107 may little or no security and may not require users to login to gain access to all or portions of the application. Contrariwise, the second application 118 may have a high level of security, and may require users to login to gain access to all or portions of the application. Similarly, the first application 107 may allow connections with other applications or systems, while the second application 118 prevents such connections.

Integrating two or more applications with different security and connectivity boundaries into one logical interactive and connected experience may be difficult for system integrators and end users. Previously, such projects typically required an extensive investment in developing an integrated user experience, or would use mash-up techniques to assemble existing visualizations systems into a single dashboard. Custom application integration development is costly and usually not feasible for system integrators and end users with limited development expertise. Mash-ups do not typically involve extensive development, but they do not provide real application integration either. Data from different applications or systems is typically just displayed side-by-side without sharing context between them.

Embodiments described herein allow system integrators and end users to create integrated user experiences for disconnected or disparate systems using scripting and web page data presentations. Scripting and web pages (e.g. hypertext markup language (HTML) pages) are technologies that system integrators and power end users are typically familiar with. Embodiments described herein enable composition and integration on user interface level where data is retrieved using a scripting application on one system while a visualization is created on the other application. At least in some cases, the embodiments do not require systems or applications to have connectivity or security integration between each other.

Accordingly, embodiments described herein provide system integrators, end users and other types of users a way to bridge boundaries between disconnected systems and create integrated user experiences using a scripting application and (e.g. HTML) web pages. Unlike deeply integrated systems, these embodiments do not require installation or development of connectors which are usually locked to the data APIs of the systems involved and typically need elevated credentials to access data. Unlike mash-up systems that allow displaying information from disconnected systems side-by-side without context shared between them, these embodiments allow deep integration of data and visualization from disconnected systems without integrating the systems or applications themselves. These embodiments also function without modifications to other connected systems' code, deployment or configuration. Thus, systems described herein are not just about accessing and integrating data over a uniform application programming interface (API) as needed, but instead are about hosting the visualizations implemented in other systems. In one example, disparate databases are connected through the first and second applications, where each application only connects to its own database.

As the term is used herein, a “scripting application” may be any type of standalone or built-in scripting application, service, widget or other software functionality that allows users to compose and/or execute scripts. The scripts may be executed within another application, or by themselves, and may result in some type of action occurring on one or more computer systems. For example, in one embodiment, the first application 107 on computer system 101 is a scripting application. The scripting application allows user 105 to create, modify and execute scripts using input 106. The scripts allow the user to display virtually any information in a dashboard or other part of an application, and further provide control over the information's formatting.

A ScriptContext object is a helper object that provides methods and properties to scripts used in a scripting application or widgets. The ScriptContext object may be passed as a global variable to scripts that run in the context of a dashboard. Each script created for a dashboard may use the ScriptContext helper object to create and return the data that is displayed in the scripting widget. Data may be returned from a script in a dashboard scripting widget by setting a value for a ReturnCollection property. When the script completes, the scripting widget will read the contents of ReturnCollection and format it for display in the dashboard. In some embodiments, the data in ReturnCollection is formatted into a grid. In other embodiments, the data in ReturnCollection is a web page that displays in the dashboard.

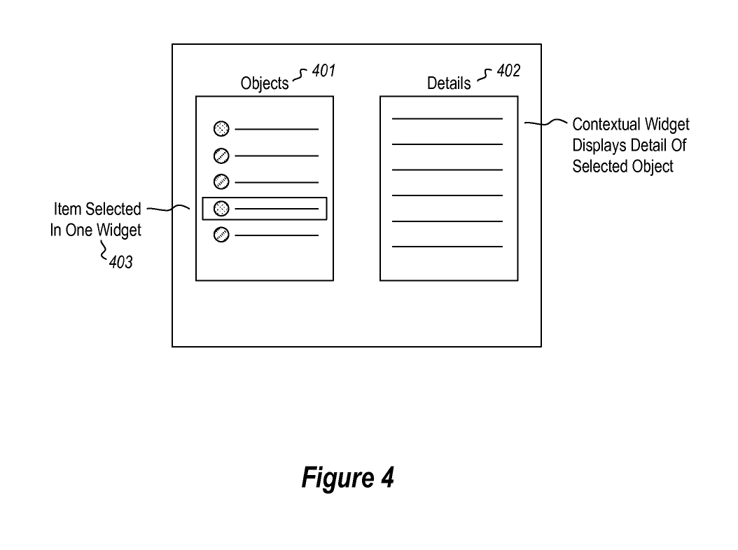

A contextual widget is one that can accept data from another widget in the dashboard. As shown in FIG. 4, when a user selects an object 403 from among the available objects 401 in a first widget, the contextual widget is updated and can use data from the first widget to determine what it should display. For example, the user may have a list of objects 401 in one widget and want to display details 402 about an object 403 when it is selected in the first widget. In order to make a script contextual, the user (e.g. 105 from FIG. 1) may add a parameter to the script that includes global selected items. This variable may include a collection of objects or alerts that are selected in another widget in the dashboard. If this parameter is included, then the script will run and refresh its data each time another object or alert is selected. The script can then use this variable to access information from the selected items in order to determine the information to display in the scripting widget.

A web browser scripting widget may be configured to display the output of a web page requested by a given script. This may involve one of the following three scenarios: 1) A simple web page requiring no parameters, 2) A web request using parameters with properties of the selected object, or 3) A web form written to interact with an operations console. In the first case involving a simple web request, a static web page is displayed in the widget. The user can pass parameters to it in the request (e.g. in request 112). It should be noted that this scenario is typically a precursor to the other scenarios since the same results may be achieved without a script using the web browser scripting widget. The scripting application (e.g. 107) may be used to generate the request for visually-interpretable information 112, which is then sent on to the second application 118.

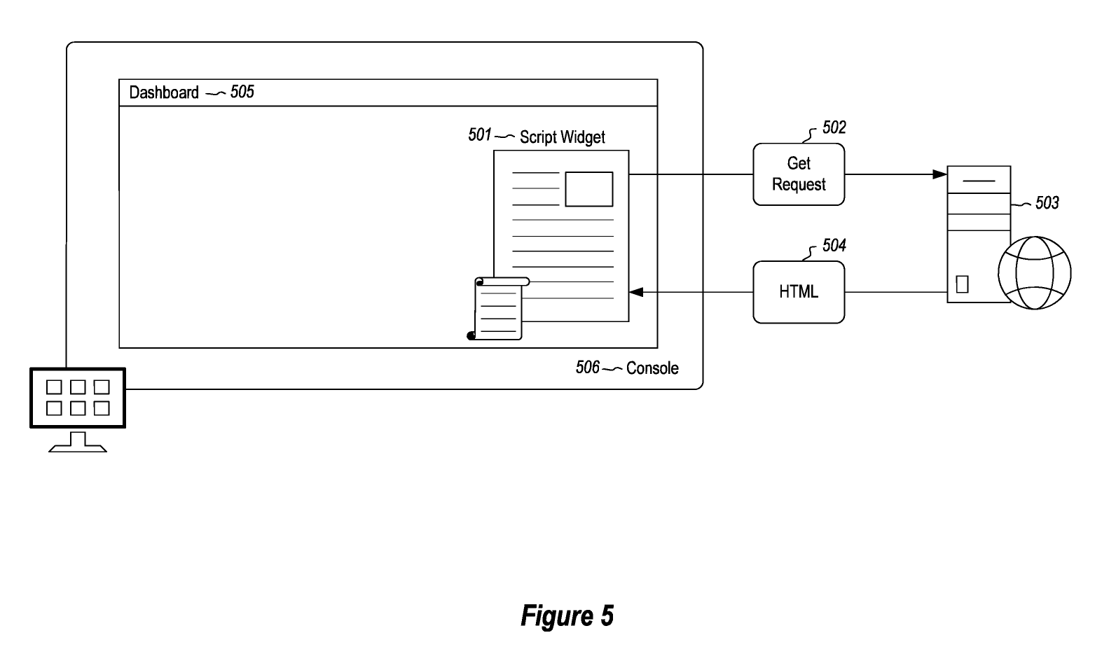

The request for visually-interpretable information 112 may include context information 113 and/or parameters that allow the user 105 to the information request for any items selected in the dashboard. In this scenario, as shown in FIG. 5, the script widget 501 may build an information request 502 (e.g. a web “get” request) with parameter values from one or more objects selected in the dashboard 505. This allows the user to perform such actions as looking up information on a selected alert or requesting information on a selected object in another application system accessible through the internet 503 (e.g. using the hypertext transfer protocol (HTTP)). A web response (e.g. HTML response 504) may then be sent back to the console 506 at the user's computer system (e.g. computer system 101 of FIG. 1). The request object created in this example is the same as the request object in the previous example for a simple web request. A parameter collection is added to this request to hold the parameter values. Note that a set of parameters is added for each selected item in case multiple items are selected.

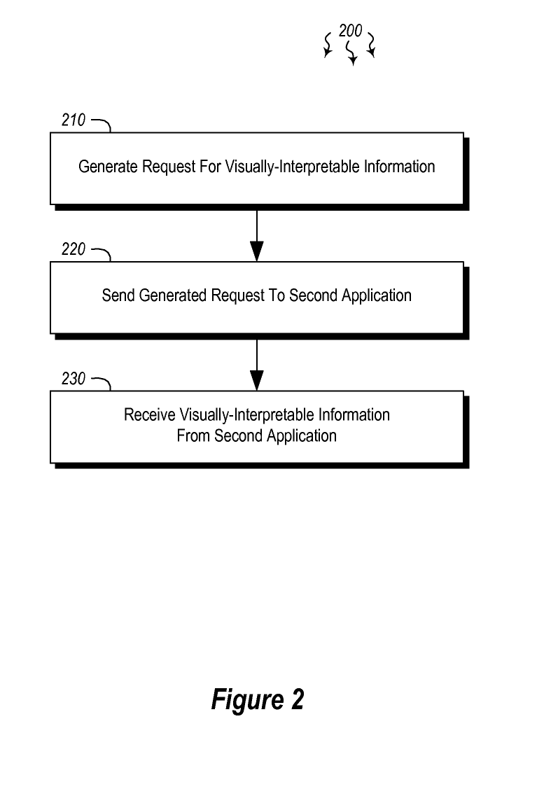

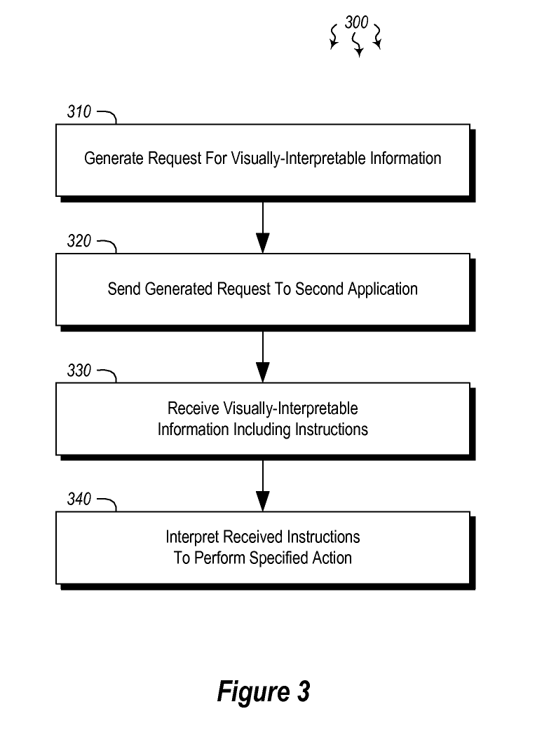

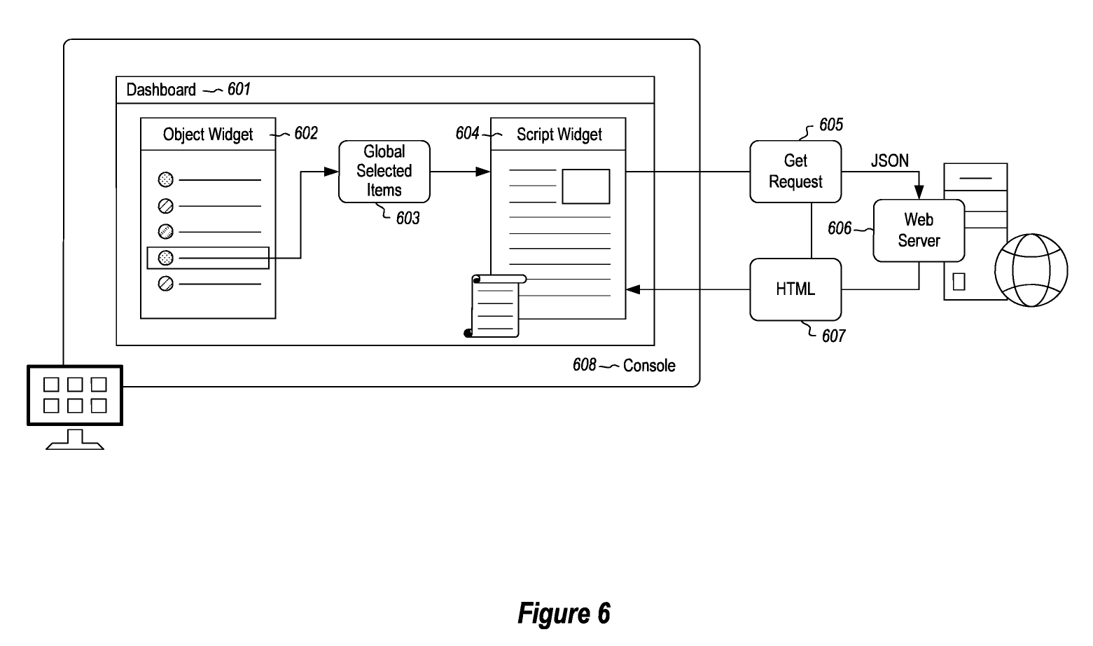

The custom web page scenario allows users complete flexibility over the data that that is retrieved and how the data is formatted. In this scenario, as generally shown in FIG. 6, a user uses the script widget 604 to build a script to run in console 608 and a web page to be processed on a web server 606. The script creates a post request by populating a “PostData” property of the request object 605 with the selected object 607 from the list of objects 602. The web page accepts the data and returns results 607 back to the console in HTML (or in some other browser-readable format). The data may be sent to the web page in JavaScript Object Notation (JSON), and, in such cases, the web page will be deserialized prior to implementation. The web page 607 can interact with the dashboard 601 and/or the console 608 using various console windowing methods or by using the console protocol in hyperlinks. These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for integrating experiences from at least two applications. The method 200 will now be described with frequent reference to the components and data of environment 100.

Method 200 includes generating, at a first application, a request for visually-interpretable information from a second application, the second application being decoupled from the first application, the request including context information associated with the first application (210). For example, the request generating module 108 of the first application 107 may generate request for information 112 requesting visually-interpretable information from second application 118. The first and second applications may be any type of software applications, and may include various modules for performing certain types of functionality. Thus, the first application may include a request generating module 108 for generating the information request 112. It should be noted, however, that the request generating module may not be part of the first application 107, and may be run separately from the first application or any other modules on computer system 101.

The request for visually-interpretable information 112 may be generated as a result of executing a script at the first application. For instance, user 105 may provide a script, or the first application 107 may access a previously created script. This script may then be executed by the first application or the computer system 101, and may cause the request for information 112 to be generated. The request for information may include context information 113 that specifies context for the information request 112. For instance, if a selected item is part of a list of items, the list of items may be provided as context for the selected item.

As indicated above, the first and second applications may be different in various ways. The two applications may have different security settings or implementations (e.g. different encryption policies or login policies), or may have different connectivity settings, interface settings, access settings or other distinguishing characteristics. As such, the first and second applications can be said to be “decoupled” from one another, each being different from the other in some manner. Thus, the decoupling between the first application 107 and the second application 118 may indicate that the first and second applications have different security boundaries (or have no security between the applications), or may indicate that the first and second applications have different connectivity boundaries, differing on how communications and connections are allowed, established and/or maintained.

One example of disconnected systems or applications may include one application that processes data and one application that provides visualizations for the data. Thus, in such cases, if the second application 118 is providing visualizations for the requested data, the second application may generate and return visually-interpretable information (such as a web page, image, presentation or other visually-interpretable data). In some cases, computer system 101 may establish a configuration or view that automatically executes the script at the first application upon implementation of the configuration or view. Thus, for example, if user 105 indicates at the first application 107 that a certain configuration or view is to be used, once implemented, that configuration or view will trigger the execution of one or more scripts, which may, in turn, cause the generation of the information request 112.

Returning to FIG. 2, method 200 includes sending the generated request to the second application (220). The communications module 104 of computer system 101 may send the generated request for information 112 to second application 118. The communications module 104 of computer system 101 may then receive visually-interpretable information 120 from the second application, where the visually-interpretable information is generated based on the context information 113 associated with the first application (230). In some cases, the second application 118 may be unaware of the data associated with the first application or the application configurations associated with the first application. The second application may thus generate visually-interpretable information 120 without knowledge of the first applications data or data types, or application configurations associated with the first application 107.

Sending this visually-interpretable information 120 without knowledge of the first application's data or configurations allows the two applications to be integrated without low-level knowledge about the other applications, or without custom interfaces. In some cases, the experiences integrated between the first and second applications are user interface experiences. In such cases, the visually-interpretable information 120 from the second information 118 may be displayed in the first application (e.g. within the console 506 of FIG. 5). The visually-interpretable information received from the second application 118 may be a markup language file (such as HTML or XML), an image file or other type of data that can be interpreted and presented to a user for display. The interpreting module 109 may interpret the visually-interpretable information 120 and display it according to the context information associated with the first application. Thus, in such cases, if the context indicates that the visually-interpretable information 120 is to be displayed in a graph, or in a list, or in a spreadsheet column or row, or in a word processing document, etc., it may be displayed in that context.

In some embodiments, the visually-interpretable information 120 received from the second application 118 also includes instructions 121 that are recognizable by the first application 107. The instructions may cause certain specified actions to be performed within the first application. This allows for interactivity between the decoupled first and second applications. The instructions may be interpreted by the interpreting module 109 and may be implemented by the action performing module 110. The action may be a single action or a series of actions, such as those that are part of a workflow. Thus, in such cases, the action may be the initiation of a workflow (or set of workflows). In this manner, instructions sent by the second application 118 provide interactivity (or at least quasi-interactivity between the applications). For example, the visually-interpretable information 120 may include instructions 121 that cause the first application 107 to act differently when a user selects something within the visually-interpretable information 120 (e.g. on a web page). In such cases, the second application 118 may know little to nothing about the first application including its configurations, settings, interfaces or data types.

In one embodiment, the first application 107 may send an element identifier and a display name for that element within the context information 113. The second application 118 may not know what the element identifier and display name means, but can provide instructions to the first application that the element is to be displayed in a certain place and that it is to be highlighted, for example, within the first application. In another example, the first application may send a specified time range with the request for information 112 (e.g. within a web page request). The second application 118 may then return portions of web page (or other) content specific to the specified time range. In this manner, a script may be executed on the first application 107 which sends a web request with context information to the second application 118. The second application 118 sends back a visualization or representation for a certain portion of data (i.e. the data specified in the request 112), without knowing the configuration settings or data types of the first application.

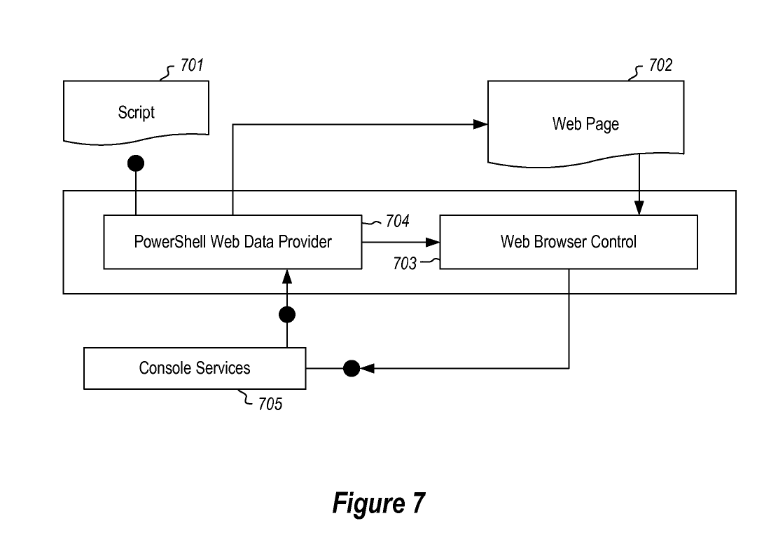

As shown in FIG. 7, a script 701 may be generated by a user or accessed from another location. The script 701 may be generated at a web data provider 704 that provides scripting capabilities. The script may generate one or more web get requests for data from another application. The web get requests may include one or more contextual selections made at a console 705. The web get requests may result in a web page 702 being returned and displayed within a web browser 703. This web page may include various types of visually-interpretable information, and may include any type of information displayable in or interpretable by a web browser. The web page itself may include instructions that are interpretable by and implementable the web browser.

Turning now FIG. 3, a flowchart is illustrated of a method 300 for integrating experiences from at least two applications. The method 300 will now be described with frequent reference to the components and data of environment 100.

Method 300 includes generating, at a first application, a request for visually-interpretable information from a second application, the second application being decoupled from the first application, the request including context information associated with the first application (310). For example, the request generating module 108 of the first application 107 may generate the request for visually-interpretable information 112. The request may include context information 113 associated with the first application, which identifies context for the requested visually-interpretable information. Method 300 further includes sending the generated request 112 to the second application (320) and receiving visually-interpretable information 120 from the second application 118. The visually-interpretable information is generated based on the context information 113 associated with the first application 107, and includes instructions 121 for the first application that, themselves, include context information 122 associated with the second application (330). The interpreting module 109 of computer system 101 may then interpret the received instructions 121 including the context information 122 associated with the second application to allow the first application to perform at least one action 111 based on the received instructions (340).

The action 111 may, for example, include displaying a visualization of at least some portion of the received visually-interpretable information 120. Other actions may include highlighting certain portions of the information, formatting the information or performing other operations in relation to the received information 120. The context associated with the second application (i.e. the context sent with the instructions 121) may indicate certain attributes or settings associated with the second application that may influence which action 111 is performed by the action performing module 110 on computer system 101, or may influence how the action is performed.

In some cases, the action 111 that is performed by the first application 107 is a native action within the first application. Thus, the second application, although decoupled from the first application, may initiate the performance of an action 111 that is native to the first application. In some embodiments, a separate data set may be joined to the visually-interpretable information 120, and is sent along with the visually-interpretable information. This separate data set may belong to a third party or other entity. In cases where the separate data set belongs to a third party, the third party data set may be incorporated with the visually-interpretable information 120 and may be displayed alongside or integrated within the visually-interpretable information received from the second application 118.

Accordingly, in this manner, methods, systems and computer program products are provided which integrate experiences from two or more decoupled applications.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. At a computer system including at least one processor, a computer-implemented method for integrating experiences from at least two applications, the method comprising:
generating, at a first application, a request for visually-interpretable information from a second application, the second application being decoupled from the first application, the request including context information associated with the first application;
sending the generated request to the second application; and
receiving one or more portions of visually-interpretable information from the second application, the visually-interpretable information being generated based on the context information associated with the first application.

2. The method of claim 1, wherein the request is generated as a result of executing a script at the first application.

3. The method of claim 2, further comprising establishing a configuration or view that automatically executes the script at the first application upon implementation of the configuration or view.

4. The method of claim 1, wherein the second application is unaware of at least one of the following: data associated with the first application or application configurations associated with the first application.

5. The method of claim 1, wherein the experiences integrated between the first and second applications comprise user interface experiences, such that the visually-interpretable information from the second information is displayed in the first application.

6. The method of claim 1, wherein the decoupling between the first application and the second application indicates that the first and second applications have different security boundaries.

7. The method of claim 1, wherein the decoupling between the first application and the second application indicates that the first and second applications have different connectivity boundaries.

8. The method of claim 1, wherein the visually-interpretable information received from the second application comprises a markup language file.

9. The method of claim 1, wherein the visually-interpretable information comprises an image file.

10. The method of claim 1, further comprising displaying the visually-interpretable information received from the second application according to the context information associated with the first application.

11. The method of claim 1, wherein the visually-interpretable information received from the second application further includes one or more instructions that are recognizable by the first application.

12. The method of claim 11, wherein the instructions cause one or more actions to be performed within the first application, allowing for interactivity between the decoupled first and second applications.

13. At a computer system including at least one processor, a computer-implemented method for integrating user interface experiences from at least two applications, the method comprising:
generating, at a first application, a request for visually-interpretable information from a second application, the second application being decoupled from the first application, the request including context information associated with the first application;
sending the generated request to the second application;
receiving one or more portions of visually-interpretable information from the second application, the visually-interpretable information being generated based on the context information associated with the first application, the visually-interpretable information including one or more instructions for the first application that include context information associated with the second application; and
interpreting the received instructions including the context information associated with the second application to allow the first application to perform at least one action based on the received instructions.

14. The method of claim 13, further comprising displaying a visualization of at least some portion of the received visually-interpretable information.

15. The method of claim 13, wherein the action performed by the first application is a native action within the first application.

16. The method of claim 13, wherein a separate data set is joined to the visually-interpretable information and is received with the visually-interpretable information.

17. The method of claim 16, wherein the separate data set belongs to a third party, such that third party data set is incorporated with the visually-interpretable information received from the second application.

18. A computer system comprising the following:
one or more processors;
one or more computer-readable storage media having stored thereon computer-executable instructions that, when executed by the one or more processors, cause the computing system to perform a method for integrating experiences from at least two applications, the method comprising the following:
generating, at a first application, a web page request requesting information from a second application, the second application being decoupled from the first application, the web page request including context information associated with the first application;
sending the generated web page request to the second application; and
receiving at least a first portion of web page content from the second application, the web page content being generated based on the context information associated with the first application.

19. The computer system of claim 18, wherein the first application includes functionality that allows scripting.

20. The computer system of claim 18, wherein the first application sends a specified time range with the web page request, and wherein the second application returns one or more portions of web page content specific to the specified time range.
